(19) United States
(12) Patent Application Publication
(10) Pub. No.: US 2026/0336115 A1
(43) Pub. Date: Oct. 29, 2026

(54) CURATING TRAINING DATA FOR ROBOT LEARNING BASED ON INFLUENCE FUNCTIONS

(71) Applicants: Toyota Research Institute, Inc., Los Altos, CA (US); The Board of Trustees of the Leland Stanford Junior University, Stanford, CA (US)

(72) Inventors: Christopher Agia, Stanford, CA (US); Rohan Sinha, Stanford, CA (US); Jingyun Yang, Stanford, CA (US); Rika Antonova, Cambridge (GB); Haruki Nishimura, Sunnyvale, CA (US); Marco Pavone, Stanford, CA (US); Mikhal Itkina, Palo Alto, CA (US); Jeannette Bohg, San Francisco, CA (US)

(73) Assignees: Toyota Research Institute, Inc., Los Altos, CA (US); Toyota Jidosha Kabushiki Kaisha, Toyota-shi (JP); The Board of Trustees of the Leland Stanford Junior University, Stanford, CA (US)

(21) Appl. No.: 19/643,493

(22) Filed: Apr. 9, 2026

Related U.S. Application Data
(60) Provisional application No. 63/796,630, filed on Apr. 29, 2025.

(51) Int. Cl. B25J 9/16

(52) U.S. Cl. CPC B25J 9/1664; B25J 9/161; B25J 9/163

(57) ABSTRACT

One embodiment of an apparatus includes one or more processors configured to: obtain a plurality of demonstration trajectories; score each demonstration trajectory based on an impact by each demonstration trajectory on a closed-loop performance of a robot policy, the impact by each demonstration trajectory determined based on one or more influence functions; filter a first subset of demonstration trajectories based on a plurality of respective demonstration trajectory scores associated with the first subset of demonstration trajectories; select a second subset of demonstration trajectories based on a plurality of respective demonstration trajectory scores associated with the second subset of demonstration trajectories, the second subset comprising one or more demonstration trajectories that impacted the closed-loop performance more positively or less negatively than the first subset; and generate a curated dataset that: (i) does not include the first subset of demonstration trajectories, and (ii) includes the second subset of demonstration trajectories.

### CROSS-REFERENCE TO RELATED APPLICATIONS

This Application claims the benefit of and priority to U.S. Provisional Patent Application No. 63/796,630, filed on Apr. 29, 2025, the entire contents of which are hereby incorporated by reference.

### TECHNICAL FIELD

Embodiments described herein generally relate to curating training data for robot learning.

### BACKGROUND

Artificial intelligence is a concept for simulating human intelligence, where machine learning allows an algorithm (e.g., a model), such as an artificial intelligence algorithm, to learn from, and make decisions based on, data without being deterministically programmed for making such decisions. A machine learning model includes a plurality of layers of parameters that are used to predict an output given an input. The machine learning model may be trained, such that the parameter weights of the model may be optimized to enable the model to provide or predict an accurate output given the input. Although there have been technological advancements over the years related to machine learning models and training of machine learning models, challenges still exist. Accordingly, improved systems, apparatuses, and/or methods of machine learning and/or machine learning model training are desired.

### SUMMARY

Systems, apparatuses, and methods for curating training data for robot learning based on influence functions are described. One embodiment of an apparatus includes one or more processors coupled to one or more memories and configured to: obtain a plurality of demonstration trajectories; score each demonstration trajectory of the plurality of demonstration trajectories based on an impact by each demonstration trajectory on a closed-loop performance of a robot policy, the impact by each demonstration trajectory determined based on one or more influence functions; filter a first subset of demonstration trajectories of the plurality of demonstration trajectories based on a plurality of respective demonstration trajectory scores associated with the first subset of demonstration trajectories; select a second subset of demonstration trajectories of the plurality of demonstration trajectories based on a plurality of respective demonstration trajectory scores associated with the second subset of demonstration trajectories, the second subset of demonstration trajectories comprising one or more demonstration trajectories that impacted the closed-loop performance of the robot policy more positively or less negatively than the first subset of demonstration trajectories; and generate a curated dataset that: (i) does not include the first subset of demonstration trajectories, and (ii) includes the second subset of demonstration trajectories.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 is an illustration of an example process flow of curating training data for robot learning based on influence functions, according to embodiments described herein;

FIG. 2 is another illustration of an example process flow of curating training data for robot learning based on influence functions, according to embodiments described herein;

FIGS. 3A, 3B, 3C, 3D, and 3E include tables of information or data related to curating training data for robot learning based on influence functions, according to embodiments described herein;

FIG. 4 is a block diagram illustrating components of an example ML model system, according to embodiments described herein;

FIG. 5 is a flow chart depicting an example process for curating training data for robot learning based on influence functions, according to embodiments described herein; and

FIG. 6 is a block diagram illustrating computing hardware utilized in one or more devices for implementing various processes and systems, according to embodiments described herein.

### DETAILED DESCRIPTION

Certain embodiments of the present disclosure provide apparatuses, methods, processing systems, and computer-readable mediums for curating training data for robot learning based on influence functions.

In robot imitation learning, policy performance is often tightly coupled with the quality and composition of the demonstration data. However, developing a precise understanding of how individual demonstrations contribute to downstream outcomes, such as closed-loop task success or failure, remains a persistent challenge. Embodiments of the present disclosure provide a technique for curating data (e.g., demonstration data) for a robot based on influence functions-referred to herein as curating performance-influencing demonstrations (CUPID). As described herein, CUPID is a robot data curation method based on a novel influence function (e.g., a theoretic formulation for imitation learning policies). Given a set of evaluation rollouts (e.g., rollout trajectories), CUPID estimates the influence of each training demonstration (also referred to herein as demonstration trajectory) on the policy's expected return (e.g., closed-loop performance). This enables ranking and selection of demonstrations according to their impact on the policy's closed-loop performance. Embodiments described herein may curate data by (1) filtering out training demonstrations that harm policy performance, and (2) selecting (e.g., sub-selecting) newly collected trajectories that will improve the policy (e.g., its performance) the most. Simulated and hardware experiments showed that the techniques described herein consistently identified which data drives test-time performance. For example, training with less than 33% of curated data may yield state-of-the-art diffusion policies on the simulated RoboMimic benchmark, with similar gains observed in hardware experiments. Furthermore, the hardware experiments showed that the techniques described herein may identify robust strategies under distribution shift, isolate spurious correlations, and/or enhance the post-training of generalist robot policies.

While some advancements in deep learning have emerged in architectural designs, data (e.g., training data) often remains an under-recognized yet critical driver of a model's overall performance. In particular, the success of scaling vision and language models may be impacted by data attribution (e.g., where model behavior may be causally linked to training data) and/or automatic data curation algorithms. For example, not all data points may contribute equally, or even positively, to a model's performance. As imitation learning is scaled and robotics datasets become increasingly diverse, developing a deeper understanding of (1) how demonstration data shapes policy behavior and (2) how maximum utility may be extracted from training datasets may be imperative to advancing policy performance toward reliable, open-world deployment.

An existing approach to curating data for robot imitation learning may retain demonstrations deemed most valuable under a heuristic, task-agnostic quality metric, resulting in a smaller dataset curated offline. This approach typically rests on the implicit assumption that the designed quality metric aligns well with the policy's downstream performance. However, such an assumption may not hold uniformly across diverse robotics tasks. While certain existing techniques attempt to learn performance-correlated heuristics using online policy experience, they do not establish strong causal links between training data and policy behavior. As a result, these methods risk misattributing the root cause of policy success or failure with respect to the training data.

In certain embodiments of the present disclosure, data curation in imitation learning is formally defined as the problem of identifying which expert demonstrations (e.g., maximally) contribute to the policy's expected return. CUPID described herein is a data curation method that directly targets this objective by leveraging influence functions to identify which demonstrations influenced a policy's predictions during closed-loop execution. Experiments showed that a demonstration's influence on expected return decomposes into a tractable sum over its state-action transitions and can be efficiently approximated using a REINFORCE-style estimator given a set of policy rollouts. Ranking demonstrations by their estimated performance impact facilitates curation in two settings: (1) filtering (e.g., filtering out) certain existing demonstrations from training sets, and (2) selecting high-impact demonstrations from newly collected or pre-collected data. While certain embodiments may provide a general and effective standalone signal for curating demonstration data, some embodiments may use such a general and effective standalone signal for curating demonstration data combined with task-agnostic quality metrics (also derived from influence scores), to identify conditions under which the integration of performance-and quality-based metrics strengthens or weakens overall curation performance.

In some embodiments, the source of technically beneficial advantages of the embodiments may be three-fold: (1) robot data curation is formulated as the problem of valuating demonstrations in accordance with their downstream impact on policy performance; (2) CUPID, a novel approach for curating imitation learning datasets (e.g., training data) based on influence functions, causally links demonstrations to the policy's expected return; and (3) the conditions under which the integration of task-agnostic quality metrics strengthens performance-based data curation, providing practical insights into when such integration is beneficial. Simulation and hardware experiments showed that curation with CUPID significantly improves policy performance in mixed-quality regimes, even when using only a fraction of the training data. Moreover, embodiments described herein identify robust strategies under test-time distribution shifts and can disentangle spurious correlations in training data that hinder generalization, such as by observing policy outcomes alone, without requiring additional supervision.

With respect to data curation in robotics, assembling larger and more diverse datasets may be beneficial for scaling efforts in robot imitation learning, yet how to extract greater utility from these datasets remains an open question. With respect to evaluating individual demonstrations for data curation, certain existing methods estimate demonstration quality offline via mutual information (i.e., without considering policy performance), while some existing methods train classifiers to distinguish successful and failed rollouts across policy checkpoints. Embodiments described herein measure the causal influence of each demonstration on the policy's expected return, providing a signal that (1) does not require observing both successes and failures, (2) uses only a single policy checkpoint, (3) is robust to spurious correlations in the policy's rollout distribution, and (4) naturally extends to selecting new data. Certain other existing methods may use data models to select from large multi-task datasets with an offline metric, while embodiments of the present disclosure focus on a single-task curation with an influence measure that directly reflects closed-loop returns from online policy rollouts.

With respect to data attribution outside robotics, data attribution methods model the relationship between training data and learned behavior, with applications in model interpretability, data valuation, machine unlearning, etc. Certain existing methods focus on improving the accuracy of data attribution methods, such as influence functions, and extending them to increasingly complex generative architectures. Some existing methods focus on improving language model pre-training and fine-tuning through data selection. However, these settings typically assume aligned training and evaluation objectives (i.e., prediction loss) and access to test-time labels. However, robot imitation learning involves an objective mismatch: policies are trained via supervised learning but evaluated through closed-loop environment interactions, where task success depends on many sequential predictions, and ground-truth action labels are unavailable at test-time.

At a high-level, the goal of data attribution methodologies is to explicitly relate model performance and behavior to the training data, so that certain counterfactual questions about the contribution of training samples towards test-time predictions may be answered. For a standard supervised learning setting, where certain model parameters may be fit on a given training dataset, a data attribution method may aim to approximate the change in the performance metric if certain samples are excluded from the model's training data.

The influence function is a data attribution technique that approximates the data attribution method without retraining any models. If a training objective is perturbed, where an infinitesimal weight may be added on the loss of some samples, the influence function estimates the change in the performance metric as a function of the weight with a first-order Taylor approximation. Therefore, the influence function may be used to (e.g., directly) approximate the leave-one-out influence of a sample. In addition, an add-one-in influence of a sample may be approximated in a similar manner.

### Embodiments Related to Curating Training Data for Robot Learning Based on Influence Functions

With respect to Imitation Learning (IL), the objective of certain embodiments of the present disclosure is to understand how demonstration data contributes to closed-loop performance in robot imitation learning. thus, a markov decision process [symbol] S, A, T, R, ρ₀ [symbol] may be considered with state space S, action space A, transition model T, reward model R, initial state distribution ρ₀, and finite horizon H. A policy may be trained to minimize a behavior cloning (BC) objective, using a dataset of expert demonstrations. Each demonstration may consist of a state-action trajectory where the robot successfully completes a task. A trajectory may be treated as either a success or a failure, corresponding to binary returns (e.g., 1 and −1 respectively). Therefore, in IL, the policy may be trained to match the distribution of successful behaviors in expert demonstrations D, rather than directly maximizing its expected return. As a result, the policy's performance is intimately linked to the relative suboptimality of the demonstration data (a function of its quality and composition) not just to validation losses, model capacity, or bias-variance tradeoffs. This makes it challenging to systematically improve performance. Certain existing methods showed that simply scaling demonstration collection may result in datasets that contain substantial redundancies and behaviors that may actually harm policy performance.

With respect to robot data curation, while some existing methods use intuitive measures of quality to curate data, such heuristics can misalign with how deep models actually learn, sometimes even worsening test-time performance compared to randomly choosing samples. Therefore, robot data curation may first be formally defined as the problem of identifying demonstration data that maximizes the policy's closed-loop performance. In particular, for a base policy trained on the demonstration data, two settings that are essential to a policy debugging toolchain may be considered. The first is that of data filtering, where the goal may be to identify and remove redundant or harmful demonstrations from D that may be limiting the performance of the base policy.

For the task of filtering k demonstrations (Task 1), from all possible k-demonstration subsets of a training dataset D, a determination may be made as to which k demonstrations should be removed from D to maximize policy performance with respect to a task objective. For data selection, the sub-selection of new demonstration data may be guided to maximally improve a base policy, given a fixed budget.

For the task of selecting k demonstrations (Task 2), from all possible k-demonstration subsets of a holdout dataset H (e.g., newly collected data ore pre-collected data), a determination may be made as to which k demonstrations should be added to D from H to maximize policy performance with respect to a task objective. In Task 2, the problem of identifying the most impactful trajectories from a newly collected batch of demonstrations or from an existing pre-collected dataset may be considered.

With respect to policy testing and evaluation, to make progress on Task 1 and Task 2, access to a dataset of rollouts of a base policy may be assumed, along with their associated returns, to estimate the task objective for the base policy. This aligns with how policies may be evaluated in practice, without principled strategies to leverage evaluations towards BC policy improvement.

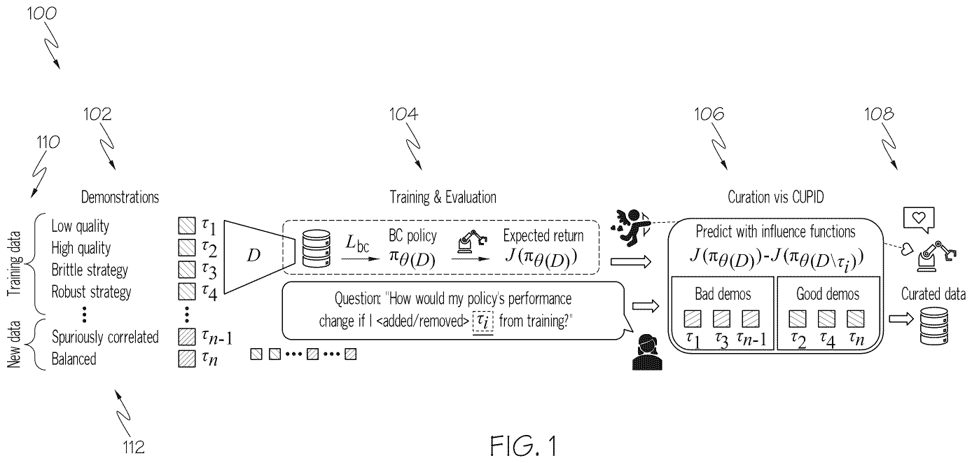

FIG. 1 is an illustration of an example process flow 100 of curating training data for robot learning based on influence functions, according to embodiments described herein. FIG. 1 illustrates CUPID, a robot data curation method that leverages influence functions to predictively answer counterfactual questions about the effect of each demonstration on downstream policy performance. As depicted, the flow 100 includes demonstrations 102, training and evaluation 104, and curation 106. The flow 100 also includes training 108 (to training a robot model based on the curated data from the curation 106). Demonstrations 102 include obtaining a plurality of demonstration trajectories, where the plurality of demonstration trajectories may include (e.g., existing) training data 110 and new data 112, were the new data 112 includes newly obtained demonstration trajectories, other/different than those included in the training data 110.

The training and evaluation 104 includes training a robot model on the training data 110, and evaluating the predictions by the trained robot model (trained on the training data 110).

The curation 106 includes predicting an impact (influence), such as a negative impact or a positive impact on a closed-loop performance of a policy, based on one or more inference functions (e.g., associated with performance inference and/or action inference), and using the results of the training and evaluation 104. The curation 106 results in a curated dataset that is optimized for (e.g., further) training a robot model.

The training 108 includes training (e.g., retraining) a robot model on the curated dataset generated by the curation 106.

Certain (e.g., essential) aspects of curating demonstration data may be diverse and often context-specific, with some existing methods evaluating demonstrations upon heuristic measures of similarity, compatibility, uncertainty, or information gain. Certain points of insight of some embodiments of the present disclosure include that solving curation problems (e.g., Task 1 and Task 2), causally connects training data to the policy's closed-loop performance. Therefore, techniques from data attribution may first be adapted to (e.g., directly) compute the influence of a training demonstration on the performance of a policy. This allows use of performance influence to (e.g., directly) curate data in alignment with the objectives of the present disclosure.

While existing data attribution methods can trace validation losses back to the training set D for curation purposes, the BC loss is not always reflective of a policy's closed-loop performance. Thus, an analogous notion of the influence function may first be developed to capture the impact of a demonstration trajectory on the closed-loop performance of an imitation learning policy. To do so, the BC training objective may be grouped into trajectory-level losses, where the performance influence of a demonstration may be defined as the application of the influence function on the policy's expected return.

With respect to definition of performance influence (Definition 1), when a policy is trained to minimize the perturbed BC objective (i.e., with certain weight added), a demonstration's performance influence is the derivative of the policy's expected return with respect to the weight discussed above. Definition 1 may enable predictively answering the counterfactual: “How would the policy's expected return change if the loss on a demonstration was upweighted—or by negating, downweighted—during training?” The performance influence may be distinguished from the influence function for two reasons: (1) the performance influence attributes the outcome of a policy's sequential decisions to time-series demonstrations, whereas the existing techniques only relate an individual labeled prediction to a single training sample; and (2) the performance influence cannot be directly computed because the policy's expected return depends on the unknown transition dynamics and reward function. To alleviate these challenges, the performance influence may be decomposed into influence scores of individual action predictions, which may be defined as action influence.

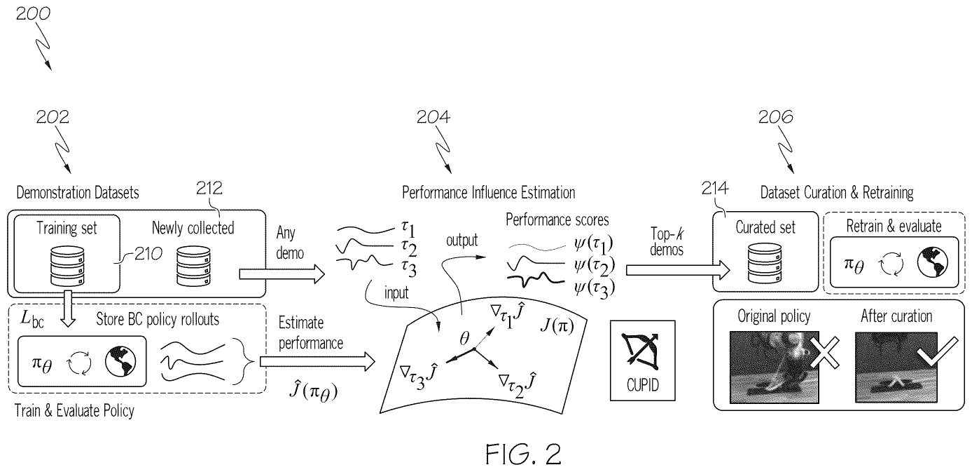

With respect to definition of action influence (Definition 2), the action influence of a state-action pair on a test state-action pair may be the influence of the state-action pair on the policy's log-likelihood. The advantage of action influence is that the quantities for determining the action influence may be computed easily given the policy weights and the training demonstrations D, such as by using the attribution methods. However, computing action influences over state-action samples from a policy rollout may (e.g., only) provide what demonstration data led to the policy taking those actions, without ascribing value to the resulting outcome (e.g., success or failure). The performance influence decomposes into the sum of individual action influences, weighted by the trajectory return. The performance influence is illustrated in FIG. 2. Moreover, additional details regarding certain aspects of the present disclosure are described further in Christopher Agia et al, “CUPID: Curating Data your Robot Loves with Influence Functions” (https://arxiv.org/pdf/2506.19121), the entire contents of which are hereby incorporated by reference. This document is referred to as “CUPID Paper” herein.

FIG. 2 is an illustration of an example process flow 200 of curating training data for robot learning based on influence functions, according to embodiments described herein. Upon training a policy on a set of demonstrations using behavior cloning, the policy may be evaluated online to collect closed-loop rollout trajectories and estimate the policy's expected return. CUPID ranks demonstration based on their measured influence on this performance estimate and selects, for example, the top-k demonstration trajectories. Thus, curating with CUPID results in a dataset of demonstrations that most strongly influences closed-loop policy success.

Similar to the flow 100 of FIG. 1 (such as described with respect to the curation 106), the flow 200 of FIG. 2 includes obtaining demonstration datasets at 202, estimating performance influence at 204, and dataset curation and retraining at 206. Obtaining demonstration datasets at 202 includes obtaining a (e.g., existing) training set 210 (that was used for training a robot model) and newly collected data 212 (e.g., demonstration trajectories that were not part of the training set 210, such as for training a robot model).

The obtained demonstration datasets from 202 may be used to estimate performance influence at 204, where the datasets (e.g., the demonstration trajectories) may be input to a model or system configured to perform the estimation, such as described further herein, and performance scores (e.g., associated with performance inference and/or action inference) for the input demonstration trajectories may be obtained as output. These scores may be used to rank the demonstration trajectories, such that a subset (e.g., a top k-subset) of the demonstration trajectories (demonstrations) may be obtained. These may be the curated dataset that is used to train (e.g., retrain) a robot model, at 206.

In some embodiments, the performance influence discussed above may be leveraged to curate data towards the filtering and selection tasks (Task 1 and Task 2) described above. In particular, the estimates of the performance influence may be used to make a first-order Taylor approximations on the leave-one-out and add-one-in influence of a demonstration trajectory. Then, the leave-one-out and add-one-in influences may be used to counterfactually estimate the change in expected return when removing or adding a set of demonstrations with a linear approximation. As a result, optimally curating data under the approximate linear model on policy performance may include selecting the least influential demonstrations from the training data D—in the case of data filtering—or selecting the most influential demonstrations from a new set of demonstrations H—in the case of data selection.

By linearly approximating policy performance changes using the performance inference, what may be termed a (linear) data model may be constructed. Using such first-order approximations for data curation can often greatly improve model performance over manual notions of quality.

In certain embodiments, a method may be constructed to estimate the performance inference from a dataset of policy rollouts by relying on policy gradient methods. The estimated performance influence becomes increasingly noisy as the number of rollouts is reduced to evaluate the policy. In some cases, demonstrations containing outlier or noisy influence scores may be penalized. Accordingly, a reward-agnostic, heuristic demonstration quality metric based on the action influence scores (action inference) may be used (e.g., in a complementary manner) for Task 1 and/or Task 2. As such, the heuristic associated with a reward-agnostic, heuristic demonstration quality metric based on the action influence scores may reduce variance on tasks requiring precise motion, while introducing bias uncorrelated with performance in other settings.

### Experiments

Certain experiments were conducted to test the efficacy of CUPID alongside existing baselines for robot data curation. These experiments took place across three simulated tasks from the RoboMimic benchmark suite and three real-world tasks with a Franka FR3 manipulator. These tasks included a taxonomy of settings where data curation may benefit policy performance. A detailed description of the tasks, datasets, baselines, evaluation protocol, and hardware setup are described, below.

With respect to evaluation, the filter-k curation task (Task 1) and the select-k curation task (Task 2) are discussed wherever applicable. For statistical significance, filter-k and select-k were started from random ~2/3 and ~1/3 subsets in RoboMimic (300 demonstrations per task total), and random ~9/10 and ~4/10 subsets on Franka tasks (120-160 demonstrations per task total), respectively. Convolutional-based diffusion policy implementation was used for all tasks to measure the effect of curation on an existing policy architecture. To reflect practical constraints, the rollout budget (i.e., the number of rollouts a curation algorithm may use) was limited to 100 and 25 for simulated and real-world tasks, respectively. Policy success rates over 500 rollouts averaged over the last 10 policy checkpoints were reported for simulated tasks, and 25 rollouts performed with the last checkpoint were reported for real-world tasks.

With respect to baselines, baselines from several methodological categories: DemInf—applicable only to filter-k (Task 1)—curates data offline (i.e., without rollouts) by maximizing mutual information, promoting diverse and predictable demonstrations; Demo-SCORE trains binary classifiers to distinguish states from successful and failed rollouts, retaining demonstrations with a high average state success probability; Success Similarity is a custom method that ranks demonstrations by their average state similarity to successful rollouts; Random chooses demonstrations uniformly at random; Oracle approximates an upper bound on performance by curating data with privileged access to ground-truth demonstration labels, for example, indicating demonstration quality, strategy robustness, or other properties.

First, curation of mixed-quality datasets was considered, where training on lower-quality demonstrations may degrade policy performance. The “Lift,” “Square,” and “Transport” tasks from RoboMimic's multi-human (MH) task suite were used, which provides ground-truth quality labels for demonstrations. The “Lift” and “Square” tasks contain three quality tiers {“low”, “medium”, “high”}, while the more complex bi-manual “Transport” task contains six quality tiers {“low-low”, “low-medium”, . . . }. On hardware experiments, the “Figure-8” task, where the robot must tie a simplified cleat hitch—a knot that follows a figure-8 pattern—was designed, which used precise manipulation of a deformable rope.

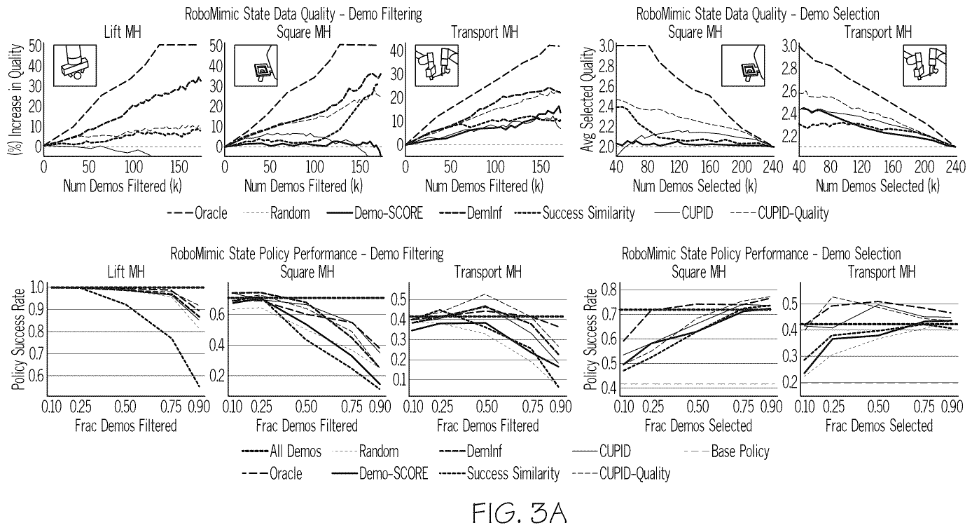

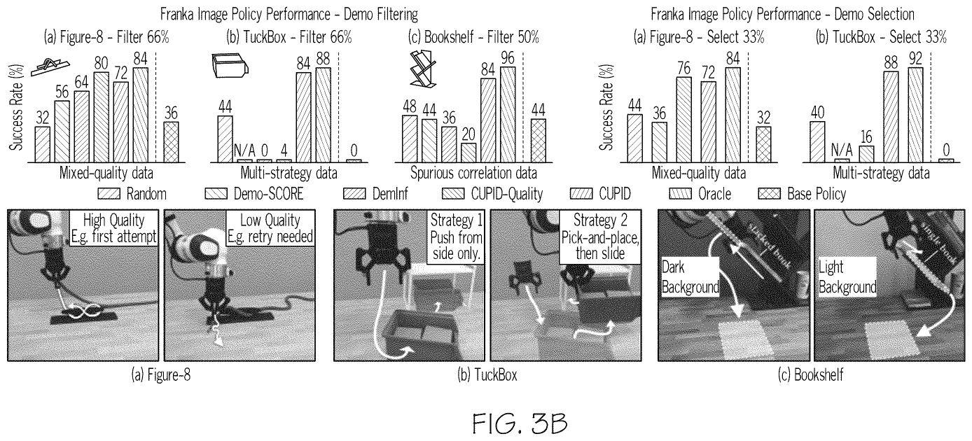

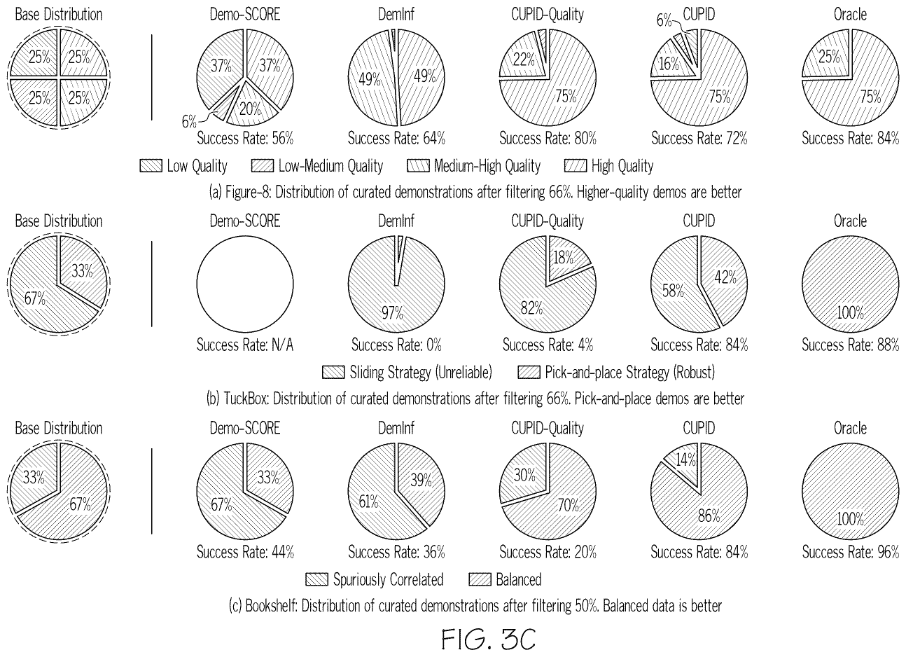

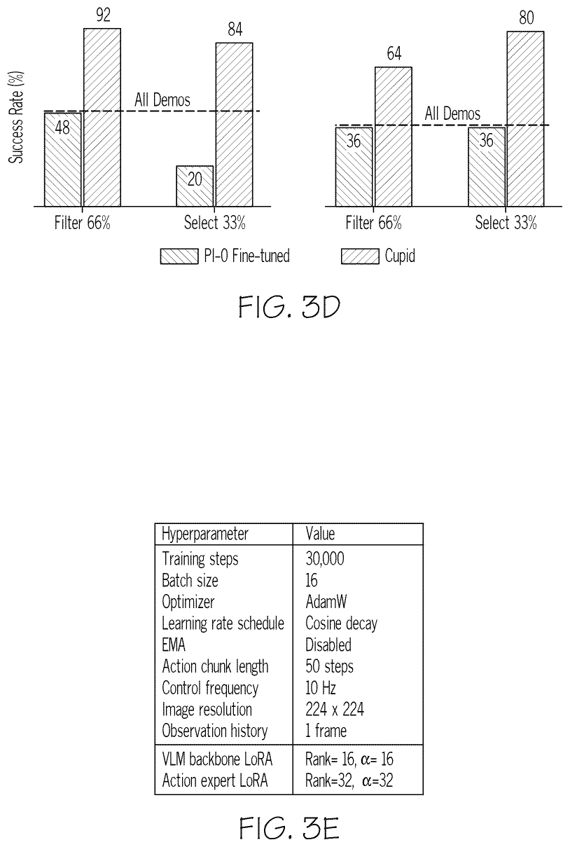

With respect to RoboMimic analysis, FIG. 3A presents the RoboMimic benchmark results: the top row shows data quality trends for filter-k and select-k across varying k, while the bottom row reports success rates of diffusion policies trained on the corresponding curated datasets. An observation is made that DemInf—which targets demonstration quality—curates datasets of the highest overall quality by RoboMimic's ground-truth labels for filter-k (top row, FIG. 3A). However, policies trained on data curated by CUPID consistently match or outperform those of DemInf (bottom row, FIG. 3A). This indicates that human perception of demonstration quality does not necessarily correspond to data that maximizes downstream policy success. Secondly, the state similarity heuristics employed by Demo-SCORE and Success Similarity were found to be relatively ineffective in challenging mixed-quality regimes, where successful and failed rollouts exhibit similar states. Lastly, CUPID-QUALITY, which evenly balances demonstration quality and downstream performance impact, attains the highest policy success rates—surpassing the Oracle in 3/5 cases, and achieving an even higher success rate than a diffusion policy on “Transport MH” while using fewer than (1) 33% of the original 300 demonstrations and (2) 10% of the model parameters. Additional details regarding the RoboMimic results are provided, below.

With respect to the Figure-8 task. FIG. 3B shows diffusion policy results on the real-world Figure-8 task. First, CUPID improves the base policy's success rate by 38% (averaged over filtering and selection). Second, as in RoboMimic, CUPID-QUALITY further strengthens curation performance, corroborating the utility of quality metrics in mixed-quality regimes. As shown in FIG. 3C (filtering; see additional details described herein), both CUPID and CUPID-QUALITY successfully retain high-quality demonstrations, whereas baselines such as Demo-SCORE discard some in favor of lower-quality demonstrations. Overall, training on lower-quality demonstrations appears to adversely affect policy performance on the figure-8 task.

Heterogeneous imitation learning datasets may contain multiple strategies for solving a task, some of which can fail under distribution shifts at deployment. A real-world “TuckBox” task was designed for experiments, where a robot must tuck a recycling bin under a receptacle by (1) sliding or (2) first repositioning it via pick-and-place (see FIG. 3B). The dataset contains a 2:1 ratio of sliding to pick-and-place demonstrations, making sliding the dominant strategy. At test time, an imperceptible distribution shift was induced by altering the bin's mass distribution, rendering sliding unreliable. In this setting, curation aimed to rebalance the dataset to promote strategies that are more robust to unforeseen shifts at deployment.

With respect to TuckBox task, FIG. 3B shows the diffusion policy results on “TuckBox.” Due to the strategy imbalance, the base policy exclusively exhibits the sliding behavior, resulting in a 100% failure rate under the distribution shift. This immediately invalidates the use of Demo-SCORE, which requires both successful and failed rollouts. CUPID does not require observing successes: by linking failures to the demonstrations that influenced them, curating with CUPID yields a policy that exhibits increased pick-and-place behavior, performing comparably (84%-88% success rate) to the Oracle. However, both DemInf and CUPID-QUALITY incorrectly associate the higher-variance pick-and-place demonstrations with lower quality, resulting in more uniform filtering across strategies (see FIG. 3C). As a result, policies trained on data curated by these baselines default to the brittle sliding strategy at deployment.

Spurious correlations in training data may cause a policy to rely on non-causal features, hindering generalization to variations in the input or task. A real-world “Bookshelf” task was designed for experiment, where a robot extracts a target book via (1) horizontal or (2) vertical pulling motion, depending on whether another book is stacked above the target book. While both strategies are equally represented in the training set, each co-occurs more frequently with a certain background color (see FIG. 3B). At evaluation, the policy was tested under slight variations in the number and position of distractor books, while keeping the white background fixed—the correlate associated with the horizontal pulling behavior.

With respect to Bookshelf task, diffusion policy results are shown in FIG. 3B. The base policy achieves only a 44% success rate, as the presence of the white background often causes the policy to extract the target book horizontally despite another book being stacked on top (causing it to fall). By training classifiers to distinguish failed from successful states, Demo-SCORE appeared to misattribute failure to the presence of rollout correlates (the stacked book) rather than causal factors (the white background). CUPID attains an 84% success rate by identifying demonstrations that causally drive failure—in this case, horizontal pulling motion with a white background—enabling dataset rebalancing that mitigates the effect of spurious correlations (see FIG. 3C). DemInf and CUPID-QUALITY incorrectly prioritize the lower-variance horizontal pulling motion, yielding negligible performance gains.

Certain mixed-quality curation experiments (see FIG. 3A and FIG. 3B) reveal that while curation strengthens performance on “Transport MH” and “Figure-8” (i.e., a fraction of the demonstrations harm policy performance), removing almost any demonstration degrades performance on “Square MH” (i.e., all demonstrations appear important). Only about 15% of the dataset is necessary to maximize performance on “Lift MH” (i.e., the dataset is highly redundant). These results indicate that the potential benefits of data curation may depend on properties of both the data and the task. For example, one possible hypothesis is that curation is most effective in complex, precision-critical settings (e.g., “Transport MH”), whereas for tasks with greater tolerance for error (e.g., “Lift MH”), existing methods may be less sensitive to training on lower-quality demonstrations.

CUPID uses a REINFORCE-style estimator to compute the performance influence of each demonstration for curation. Thus, the accuracy of estimated performance influences depends on the number of policy rollouts. While REINFORCE often yields high-variance gradient estimates under limited rollout budgets, such as in reinforcement learning contexts, the curation objective of the present disclosure imposes a lower fidelity requirement: since curation with CUPID involves top-k selection, it suffices to rank helpful demonstrations above harmful ones (requiring fewer rollouts) rather than to estimate performance influence precisely (requiring many rollouts). In some cases, the ranking of demonstrations stabilizes with approximately m ∈[25, 50] rollouts on “Lift MH” and “Square MH,” and m∈[50,100] rollouts on “Transport MH.” Similarly, only m=25 rollouts were used for real-world Franka tasks (FIG. 3B). These results support the practicality of CUPID under realistic rollout budgets, while noting that more complex tasks (e.g., “Transport MH”) may benefit from a greater number of rollouts.

In FIG. 3D, it is shown that datasets curated by CUPID for single-task diffusion policies can significantly improve the finetuned performance of a generalist Vision-Language-Action (VLA) model, π₀ (shown in FIG. 3D as “PI-0”). While CUPID is, in principle, tailored to the specific policy used during rollouts, it consistently identifies low-quality, stochastic behaviors in Figure-8 task and unreliable strategies in TuckBox task (FIG. 3C)—both intrinsic properties of the data. Filtering these poorer demonstrations (or selecting better ones) is thereby can improve the performance for any policy. This highlights a positive direction to alleviate the computational cost of CUPID in large-scale settings: by using smaller, single-task policies to curate datasets for larger, multi-task models.

With respect to VLA robustness, FIG. 3D also suggests that scaling the pre-training of VLA models does not inherently enable them to leverage their generalist knowledge to, for example, ignore low-quality behaviors or brittle strategies in demonstration data. That is, data curation still appears important for VLA post-training.

In certain embodiments, the problem of data curation for robot imitation learning is mitigated. CUPID, a novel data curation method that uses influence functions to measure the causal impact of a demonstration on the policy's closed-loop performance, provides results that highlight the general utility of performance-based curation for two key curation tasks—filtering existing training demonstrations and sub-selecting new demonstrations—and across diverse curation settings, where a policy's test-time performance varies with the choice of training data. Among key problems in robotics, it is inherently difficult to develop strong intuitions about how training data influences downstream policy behavior, and to delineate why a policy trained exclusively on expert demonstration data would exhibit suboptimal performance at deployment.

Additional details are provided, below, with respect to the implementation of CUPID, the experiments conducted, along with extended results and analysis, as well as supporting derivations for the data curation methods of the present disclosure.

With respect to diffusion policy, an action may be generated by iteratively denoising an initially random action over T steps using a noise prediction network. Certain parameters of the noise prediction network may be fit to a BC objective, where the noise prediction network may be trained to predict random noise added to the action at randomly sampled timesteps of the diffusion process using a loss function.

Influence approximations or determining action influences (based on a squared value of loss) may involve: (1) leave-one-out influences determined in accordance with the present disclosure were empirically found to correlate better with actual changes in a diffusion model's loss than those determined by certain existing methods (based on a loss, without the squaring); (2) theoretical analysis also showed that the determination made in accordance with the present disclosure more closely aligns with a distributional formulation of the leave-one-out influence compared to that determined by certain existing methods (based on a loss, without the squaring); and (3) the determination in accordance with the present disclosure (based on a squared value of loss) significantly reduces the computational cost of computing action influences for policies with high-dimensional action spaces.

With respect to accuracy-efficiency tradeoff, it is noted that certain embodiments of the present disclosure for computing the performance influence of a demonstration is agnostic to the choice of influence estimation technique, allowing users to balance trade-off between accuracy and efficiency based on available computational resources, and enabling integration of improved data attribution methods.

Certain hyperparameters are used for CUPID and CUPID-QUALITY across all experiments.

For performance influence, for all tasks, the trajectory return may be defined as R(τ)=1 if τ completes the task, and R(τ)=−1 otherwise (if the task is not completed). As a result, every rollout trajectory τ provides information on the utility of each demonstration toward the policy's closed-loop performance. It was also found that CUPID works with alternative return definitions—for example, focusing solely on successful rollouts by setting R(τ)=0 when τ fails.

For action influence, determining the gradient of an expectation was used. For all tasks, the expectation was approximated using a batch of B=64 samples.

For data attribution, TRAK was leveraged to efficiently determine action influences. First, TRAK uses random projections P~N (0,1)^{p×d}, where p is the number of model parameters and d<<p is the specified projection dimension, to reduce the dimensionality of the gradients. Second, TRAK ensembles influence scores over C independently trained models (i.e., from different seeds) to account for non-determinism in learning. In the experiments, the standard projection dimension of d=4000 was used, and computational cost was minimized by using only a single policy checkpoint C=1, noting that ensembling over C>1 policy checkpoints may improve the accuracy of the influence scores.

Moreover, it is additionally noted that taking weighted combinations of score functions may involve first normalizing them to equivalent scales. Hence, certain embodiments may uniformly normalize demonstration scores within the range [0,1] (i.e., producing an absolute ranking of demonstrations). This approach can be applied to combine an arbitrary number of demonstration score functions.

As shown in FIG. 3B, hardware experiments involved a Franka FR3 manipulator robot. A single ZED 2 camera was used to capture RGB-D observations and disregard the depth information. The image-based policies processed 256×256 downsampled RGB observations and predicted sequences of end-effector poses for the manipulator, which were tracked using operational space control.

For diffusion policy (DP), the convolutional-based diffusion policy architecture was used for efficiency. For state-based tasks (e.g., in RoboMimic; FIG. 3A), actions were generated solely using a noise prediction network. For image-based tasks (e.g., on hardware; FIG. 3B), the policy π_{θ}contains two sets of parameters corresponding to a ResNet-18 encoder E_{θo} and the noise prediction network. When scoring demonstrations, action influences may be determined over all available policy parameters, noting that one might also consider using a subset of the parameters, for example, those of the noise prediction network or an alternative action head, under reduced computational budgets.

For other optimizations, in preliminary experiments, it was found that certain existing diffusion policy may be (1) heavily over-parameterized and (2) converged in performance much earlier in training than the specified maximum number of epochs. Thus, to accelerate experimentation in RoboMimic (FIG. 3A), the following was performed: (1) manually determining the smallest model size that performed similarly to the existing policy and (2) adjusting the maximum number of epochs to the point where additional training would result in no further performance gains. The model size and training epochs were kept consistent across all curation methods for a given RoboMimic task. For real-world hardware experiments, the same model size was used, and the number of training steps was limited to 200K across all tasks. All other diffusion policy hyperparameters were consistent with the existing implementation.

For generalist robot policy (π ₀), Physical Intelligence's π ₀ Vision-Language-Action (VLA) policy was fine-tuned via Low-Rank Adaptation (LoRA) on the Figure-8 and TuckBox tasks. To ensure the post-trained policy's performance is solely a result of the properties of the curated dataset used for training, an existing fine-tuning parameter configuration was used, and all hyperparameters were kept fixed across experiments (see Table 1 shown in FIG. 3E). Trained was performed on 2 NVIDIA RTX 4090 GPUs, which took approximately 15 hours under the configuration in Table 1 shown in FIG. 3E. In initial experiments, training for 30K steps was performed to compensate for mismatch between a robot's action space (target end-effector poses tracked via operational space control) and the action spaces used to pre-train the base π ₀ policy (absolute joint angles). In addition, it was found that using a descriptive prompt for the task yield performant policies. These prompts were fixed across training, evaluation, and all curation settings. For the TuckBox task, the instruction “Move the blue box underneath the white shelf” was used to avoid biasing the policy towards a particular behavior mode (e.g., “sliding” or “pick-and-place”). For the Figure-8 task, the instruction “Pick up the red rope, then tie a FIG. 8” was used, where it was found that the two-step instruction increases performance over shorter instructions like “Tie the cleat.” Similar to the diffusion policy experiment, a separate π ₀ model was fine-tuned for each curation task—filter-k (Task 1) and select-k (Task 2)—using their corresponding base demonstration datasets. Then, additional π ₀ models were fine-tuned on datasets curated by the methods of the present disclosure.

Here, additional details regarding the real-world hardware tasks and their corresponding datasets are provided.

The Figure-8 dataset contains 160 demonstrations evenly split across four quality tiers. Higher quality demonstrations complete the task at a constant rate without errors, while lower-quality demonstrations vary in progression rate and include retry or recovery behaviors. Therefore, the Figure-8 task intends to reflect a practical setting where demonstrations of varying properties are introduced during data collection, whether organically or deliberately, for example, to improve policy robustness to recoverable failures. Thus, curation algorithms that distinguish demonstrations upon notions of quality (e.g., predictability) were expected to perform well on this task, which is consistent with the findings shown in FIG. 3B and FIG. 3D.

The TuckBox dataset contains 120 demonstrations split 2:1 between two subsets: 80 demonstrations solve the task by sliding the box under the receptacle, while 40 demonstrations first reposition the box in front of the receptacle via pick-and-place. Although the sliding strategy appears more smooth and involves just a single step, it is rendered unreliable by imperceptible test-time distribution shifts to the box's mass distribution. As such, TuckBox stands conceptually opposite to Figure-8, whereby attending to heuristic properties of demonstrations (e.g., quality) may result in poor curation performance (as shown in FIG. 3B).

For Bookshelf, the robot extracts a target book that is either shelved alone—affording a simple, horizontal pulling motion—or with another book stacked on top of it (i.e., a bookstack). In the bookstack case, the robot extracts the target book using a vertical pulling motion, such that the stacked book does not fall off the shelf in the process (see FIG. 3B). In total, the Bookshelf dataset contains 120 demonstrations split across three subsets: (1) 60 demonstrations feature the target book shelved alone with a white background, (2) 20 demonstrations feature the bookstack with a white background, and (3) 40 demonstrations feature the bookstack with a dark background. All subsets feature task-irrelevant distractor books on other shelves.

For spurious correlations in training data, although the vertical pulling solution to the bookstack case is demonstrated in scenes with both white and dark backgrounds, the disproportionate number of demonstrations in subset (1) versus subset (2) may spuriously correlate the horizontal pulling motion with the white background. Such spurious correlations may result in causal confusion, where the policy ignores the bookstack, attends the white background, and executes the failing horizontal strategy.

For spurious correlations in rollout data, while TuckBox or Bookshelf represents another limiting case for curating data with quality metrics, it also presents an additional challenge for methods that seek to curate data using online experience. For example, approaches that attend to differences in states between successful and failed policy rollouts may be susceptible to spurious correlations in the rollout data. As an example, if successful rollouts were observed when the target book is shelved alone and failed rollouts were observed when another book is stacked above the target, then training a classifier to distinguish successful from failed states may wrongly attribute failures to the presence of the stacked book. Curating demonstrations with such a classifier would, in turn, worsen the spurious correlation in the training data. Thus, embodiments of the present disclosure posit that handling more challenging cases of spurious correlations in real-world data will involve methods that causally attribute the outcomes of observed test-time experiences to the training data, such as CUPID.

For DemInf, an existing implementation was used. It is noted that DemInf curates data offline—that is, without using any policy rollouts—and is at present only applicable to the demonstration filtering setting.

For Demo-SCORE, a new implementation was constructed based on existing information. Given an assumed fixed budget of m=100 rollouts for RoboMimic experiments, 25 rollouts were collected from C=4 policy checkpoints throughout training. Three-layer multi-layer perceptron (MLP) classifiers were trained with hidden dimensions on the first three rollout sets, and the best classifier was selected via cross-validation on the last 25 rollouts. Since the rollout budget was reduced to m=25 rollouts for hardware experiments, 25 rollouts were collected from the last C=1 policy checkpoint. Then, a single ResNet-18 encoder and three-layer classification head were trained with hidden dimensions on 20 of the rollouts, leaving 5 validation rollouts to monitor for overfitting. All classifiers were trained with a heavy dropout of 0.3 and an AdamW weight decay of 0.1 to prevent overfitting. Use of Demo-SCORE was extended for demonstration selection.

For Success Similarity, a custom robot data curation algorithm was designed that, similar to Demo-SCORE, evaluates demonstrations based on a heuristic measure of similarity with respect to successful policy rollouts. Instead of training classifiers, Success Similarity measures the average state-embedding similarity of a demonstration with respect to all successful rollouts. For image-based states, experiment was done with various embedding functions, including ResNet, DINOv2, and the policy's vision encoder, and ultimately found the policy's vision encoder to work best in RoboMimic. The embedding function was set to identity for low-dimensional states. The distance function D was chosen for compatibility with embedding functions: that is, L2 distance for policy encoder embeddings and cosine distance for DINOv2 embeddings.

For comparison to performance influence (CUPID), Success Similarity may be interpreted as replacing the action influence with a state-based proxy in an attempt to estimate the performance contribution of a demonstration. In RoboMimic experiments (FIG. 3A), this approach performs comparably to Demo-SCORE, and in some cases, even outperforms it—without requiring the training of any additional models. However, Success Similarity performs consistently worse than CUPID across all tasks, supporting findings that influence functions offer a substantially stronger causal signal than heuristic measures of similarity.

For each task, the Oracle method represents a best attempt to curate data assuming privileged access to ground-truth demonstration labels. For the RoboMimic and Figure-8 tasks, the Oracle ranks demonstrations in descending order of quality, choosing high-quality demonstrations before low-quality demonstrations. For the TuckBox task, the Oracle first chooses all demonstrations exhibiting the more robust pick-and-place strategy before any demonstration exhibiting the more brittle sliding strategy. Lastly, for the Bookshelf task, the Oracle chooses demonstrations to minimize the effect of the known spurious correlation (i.e., horizontal pulling motion in the presence of a white background), resulting in a more balanced curated dataset. These definitions of the Oracle applied identically to the filter-k (Task 1) and select-k (Task 2) curation tasks experimented with respect to the present disclosure.

For additional baselines, a number of additional custom baselines were implemented, such as curating data based on policy loss, policy uncertainty, state diversity, and action diversity. However, they exhibited relatively poor performance (and excluded).

For performance vs. data quality, one of the findings was that the performance of an existing policy does not strictly correlate with the perceived quality of its training data. Factors such as redundancy, balance, and coverage of the dataset all play a role in determining policy performance. This is illustrated in the Oracle filter-k results (left three plots of FIG. 3A). While the top row shows a monotonic increase in average dataset quality as lower-quality demonstrations are filtered out, the bottom row reveals (1) a consistent performance drop for diffusion policies on 2 out of 3 tasks, and (2) performance degradation when too many demonstrations are removed. Similar analysis applies to the select-k setting.

For performance vs. task complexity, an evaluation was done on curation performance across three RoboMimic tasks of increasing complexity—“Lift MH,” “Square MH,” and “Transport MH.” On the simplest task, “Lift MH,” diffusion policies achieved 100% success despite training on all demonstrations, indicating that low-quality demonstrations have minimal impact and can be safely filtered. A similar trend was observed for the moderately difficult “Square MH” task, where the policy benefits from access to all demonstrations regardless of their quality. However, performance degrades more quickly as demonstrations are filtered, suggesting increased sensitivity to data quantity due to the task's higher complexity relative to “Lift MH.” Finally, on the challenging “Transport MH” task, which requires precise bi-manual coordination, both CUPID and CUPID-QUALITY significantly outperform the base policy. These results suggest that curation of mixed-quality datasets is most beneficial for complex, precision-critical tasks.

An ablation investigation was done in RoboMimic evaluating the quality of datasets curated by CUPID and CUPID-QUALITY under varying numbers of rollouts, m∈{1, 5, 10, 25, 50, 100}. For “Lift MH” and “Square MH,” performance influences stabilized around m∈[25,50], yielding quality trends similar to those obtained with m=100. For “Transport MH,” quality trends continue to evolve until approximately m∈[50,100] rollouts, indicating that more rollouts are beneficial for accurate influence estimation in complex task settings—where curation has the greatest effect on performance.

For additional results for Franka π ₀ (curated dataset transfer), two questions were investigated: (1) Can datasets curated with one policy architecture result in increased performance when used to train another policy with a different architecture? (2) How influential is curation for policies that have been pre-trained on large-scale multi-task datasets?

For curation transfer, with respect to the first question, it was shown that datasets curated using diffusion policies significantly increase the performance of fine-tuned π ₀ policies relative to fine-tuning on the base, uncurated datasets. These results may be attributed to two causes: first, it was found that both the diffusion policy and π ₀ have sufficient capacity to accurately fit the training data distribution, and thus, they should learn a similar behavior distribution from the training data; second, as the TuckBox experiment shows in FIG. 3B, the methods described herein can effectively identify behaviors in the demonstration data that are not robust. While on-policy evaluations (i.e., rollouts) are used to identify such brittle behaviors, these are purely properties of the training demonstration data. Therefore, filtering out poor behaviors will increase the performance of any policy. Similarly, on the high-precision Figure-8 task, filtering out more noisy, low-quality demonstrations is likely to improve performance for any policy.

For VLA robustness, with respect to the second question, it was found that even when the base policy is pre-trained on a large, diverse, multi-task dataset, curation is still helpful to yield strong fine-tuned performance. π ₀ policies trained on the base demonstration datasets were unable to reliably complete certain tasks in the experiments. Policies trained on curated datasets attained significantly higher success rates. As such, these results indicate that simply training VLM-based policies on more data and more tasks does not strictly result in pre-conditioned policies that use their generalist knowledge to “ignore” low-quality behaviors or brittle strategies in demonstration data—that is, data curation is still helpful.

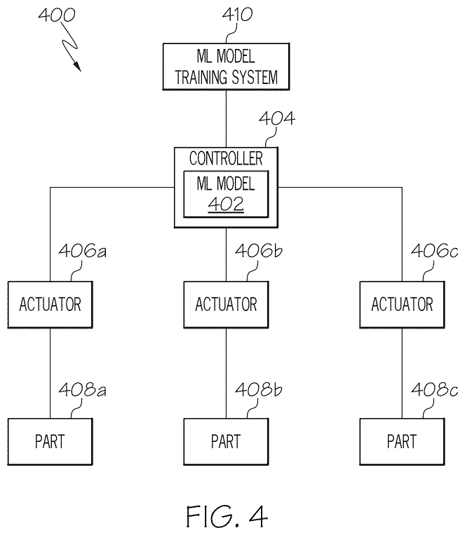

FIG. 4 is a block diagram illustrating components of an example machine learning (ML) model system 400. As depicted, the system 400 includes a controller 404 including ML model 402, where ML model 402 may be an example of a robot model, such as configured or trained to control a robot. In certain examples, the controller 404 may be a controller for a robot system or a vehicle control system. Other examples of systems may also be possible consistent with the present disclosure.

The system 400 includes a plurality of actuators 406 (actuators 406a-c) coupled to the controller 404 and to a plurality of parts 408 (parts 408a-c), where the parts 408 may be parts for a robot system, a vehicle control system, or similar. Based on the prediction by ML model 402, the controller 404 may determine how the parts 408 may be actuated, respectively, by the actuators 406, such as to control a robot or a vehicle. For example, the controller 404 may generate and send (to an actuator) a control signal based on the prediction by ML model 402, such as to cause the part to be actuated according to the prediction.

In some embodiments, the ML model 402 (or the ML model system 400) may be trained (e.g., retrained) using a dataset that is curated based on training data that was used to pre-train the ML model 402 as well as newly obtained demonstration data, such as described herein with respect to FIG. 1 or 2. For example, the ML model 402 may be trained using a ML model training system 410 depicted in FIG. 4, which may include hardware and software components configured to perform the methods described herein with respect to FIG. 1 or 2, such as those of CUPID.

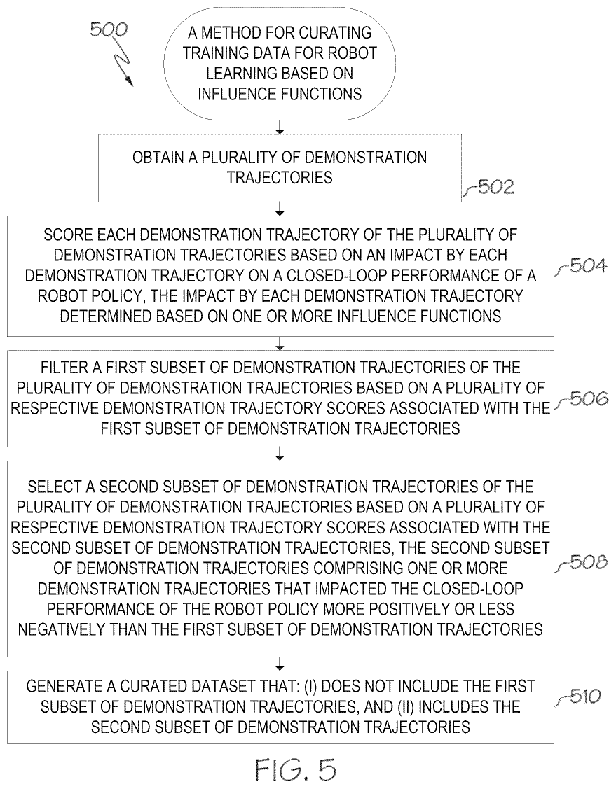

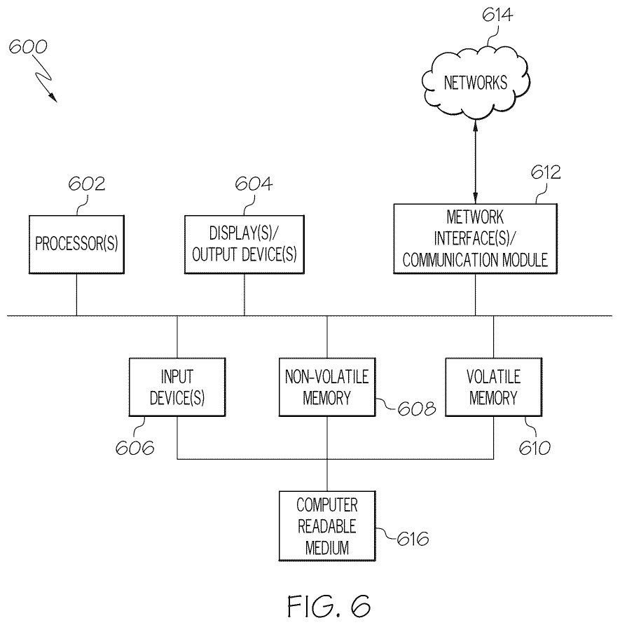

FIG. 5 is a flow chart depicting an example process, method 500. Method 500 may be performed for curating training data for robot learning based on influence functions. In certain embodiments, method 500 can be implemented by the model training system 410 of FIG. 4, and/or computing device 600 of FIG. 6.

Method 500 begins, at block 502, with obtaining a plurality of demonstration trajectories. In certain embodiments, obtaining a plurality of demonstration trajectories at block 502 may be an example of obtaining a plurality of demonstration trajectories, such as described with respect to FIG. 1 or 2.

Method 500 proceeds, at block 504, with scoring each demonstration trajectory of the plurality of demonstration trajectories based on an impact by each demonstration trajectory on a closed-loop performance of a robot policy, the impact by each demonstration trajectory determined based on one or more influence functions. In certain embodiments, scoring each demonstration trajectory at block 504 may be an example of scoring a demonstration trajectory, such as described with respect to FIG. 1 or 2.

Method 500 proceeds, at block 506, with filtering a first subset of demonstration trajectories of the plurality of demonstration trajectories based on a plurality of respective demonstration trajectory scores associated with the first subset of demonstration trajectories. In certain embodiments, filtering the first subset of demonstration trajectories at block 506 may be an example of filtering a subset of demonstration trajectories for curated dataset, such as described with respect to FIG. 1 or 2.

Method 500 proceeds, at block 508, with selecting a second subset of demonstration trajectories of the plurality of demonstration trajectories based on a plurality of respective demonstration trajectory scores associated with the second subset of demonstration trajectories, the second subset of demonstration trajectories comprising one or more demonstration trajectories that impacted the closed-loop performance of the robot policy more positively or less negatively than the first subset of demonstration trajectories. In certain embodiments, selecting the second subset of demonstration trajectories at block 508 may be an example of selecting a subset of demonstration trajectories for curated dataset, such as described with respect to FIG. 1 or 2.

Method 500 proceeds, at block 510, with generating a curated dataset that: (i) does not include the first subset of demonstration trajectories, and (ii) includes the second subset of demonstration trajectories. In certain embodiments, generating the curated dataset at block 510 may be an example of curating a dataset based on one or more influence functions, such as described with respect to FIG. 1 or 2.

In certain embodiments, the plurality of demonstration trajectories comprise a plurality of robot demonstrations received from a robot, the plurality of robot demonstrations performed using the robot operated or teleoperated by an operator.

In some embodiments, method 500 further comprises ranking the plurality of demonstration trajectories based on a plurality of respective demonstration trajectory scores associated with the plurality of demonstration trajectories, wherein the first subset of demonstration trajectories comprises one or more demonstration trajectories that are ranked lower than each demonstration trajectory of the second subset of demonstration trajectories of the plurality of demonstration trajectories.

In certain embodiments, the curated dataset comprises one or more demonstration trajectories that are ranked higher than all other demonstration trajectories of the plurality of demonstration trajectories.

In some embodiments, selecting the second subset of demonstration trajectories is further based on the one or more demonstration trajectories of the second subset of demonstration trajectories being ranked higher than the first subset of demonstration trajectories.

In certain embodiments, method 500 further comprises performing a first-order Taylor approximation on one or more of a leave-one-out impact of a demonstration trajectory or an add-one-in impact of the demonstration trajectory to determine the impact by each demonstration trajectory on the closed-loop performance of the robot policy.

In some embodiments, the one or more influence functions are associated with one or more of a performance inference or an action inference.

In certain embodiments, the plurality of demonstration trajectories do not include a successful rollout trajectory.

In some embodiments, obtaining the plurality of demonstration trajectories comprises obtaining one or more newly obtained demonstration trajectories, and the second subset of demonstration trajectories comprises the one or more newly obtained demonstration trajectories.

In certain embodiments, method 500 further comprises training a machine learning model on the curated dataset.

As described herein, method 500 provides a technical solution including techniques that are described herein as consistently identifying which data drives test-time performance. Accordingly, method 500 may enable identification of robust strategies under distribution shift, isolate spurious correlations, and/or enhance the post-training of generalist robot policies, to provide a dataset that is more robust and reliable for training a model for improved prediction performance.

Turning to FIG. 6, a block diagram illustrates an example of a computing device 600, through which embodiments of the disclosure can be implemented, such as (by way of non-limiting example) ML model training system 410 of FIG. 4, and/or any other device described herein. The computing device 600 described herein is but one example of a suitable computing device and does not suggest any limitation on the scope of any embodiments presented. Nothing illustrated or described with respect to the computing device 600 should be interpreted as being required or as creating any type of dependency with respect to any element or plurality of elements. In various embodiments, a computing device 600 may include, but need not be limited to, ML model training system 410 of FIG. 4. In an embodiment, the computing device 600 includes at least one processor 602 and memory, such as non-volatile memory 608 and/or volatile memory 610. The computing device 600 can include one or more displays and/or output devices 604 such as monitors, speakers, headphones, projectors, wearable-displays, holographic displays, and/or printers, for example. The computing device 600 may further include one or more input devices 606 which can include, by way of example, any type of mouse, keyboard, disk/media drive, memory stick/thumb-drive, memory card, pen, touch-input device, biometric scanner, voice/auditory input device, motion-detector, camera, scale, etc.

The computing device 600 may include non-volatile memory 608, volatile memory 610, or a combination thereof. Examples of non-volatile memory 608 may include read only memory (ROM), flash memory, etc. Examples of volatile memory 610 may include random access memory (RAM), etc. A network interface 612 can facilitate communications over a network 614 via wires, via a wide area network, via a local area network, via a personal area network, via a cellular network, via a satellite network, etc. Suitable local area networks may support wired Ethernet and/or wireless technologies such as, for example, wireless fidelity (Wi-Fi). Suitable personal area networks may support wireless technologies such as, for example, IrDA, Bluetooth, Wireless USB, Z-Wave, ZigBee, NFC and/or other short distance communication protocols. Suitable personal area networks may similarly support wired computer buses such as, for example, USB and FireWire. Suitable cellular networks may support, but are not limited to, technologies such as LTE, WiMAX, UMTS, CDMA, and GSM. Network interface 612 can be communicatively coupled to any device capable of transmitting and/or receiving data via the network 614. Accordingly, the hardware of the network interface 612 can include a communication transceiver for sending and/or receiving any wired or wireless communication. For example, the network interface hardware may include an antenna, a modem, LAN port, Wi-Fi card, WiMax card, mobile communication hardware, short distance communication hardware, satellite communication hardware and/or any wired or wireless hardware for communicating with other networks and/or devices.

A computer readable storage medium 616 may include a plurality of computer readable mediums, each of which may be either a computer readable storage medium or a computer readable signal medium. A computer readable storage medium 616 may reside, for example, within an input device 606, non-volatile memory 608, volatile memory 610, or any combination thereof. A computer readable storage medium 616 can include tangible media that is able to store instructions associated with, or used by, a device or system. A computer readable storage medium 616 includes, by way of non-limiting examples: RAM, ROM, cache, fiber optics, EPROM/Flash memory, CD/DVD/BD-ROM, hard disk drives, solid-state storage, optical or magnetic storage devices, diskettes, electrical connections having a wire, or any combination thereof. A computer readable storage medium 616 may also include, for example, a system or device that is of a magnetic, optical, semiconductor, or electronic type. Computer readable storage mediums and computer readable signal mediums are mutually exclusive. For example, ML model training system 410 of FIG. 4 may utilize a computer readable storage medium to store data related to curating training data for robot learning based on influence functions.

A computer readable signal medium can include any type of computer readable medium that is not a computer readable storage medium and may include, for example, propagated signals taking any number of forms such as optical, electromagnetic, or a combination thereof. A computer readable signal medium may include propagated data signals containing computer readable code, for example, within a carrier wave. Computer readable storage media and computer readable signal media are mutually exclusive.

The computing device 600, such as corresponding to ML model training system 410 of FIG. 4 may include one or more network interfaces 612 to facilitate communication with one or more remote devices, which may include, for example, client and/or server devices. In various embodiments, the computing device 600 may be configured to communicate over a network, such as network 614, with a server or other network computing device to transmit and receive data related to curating training data for robot learning based on influence functions. A network interface 612 may also be described as a communications module, as these terms may be used interchangeably.

As illustrated above, various embodiments for curating training data for robot learning based on influence functions are disclosed. It would be apparent to one of ordinary skill in the art that, while certain embodiments are described with respect to curating training data for robot learning based on influence functions for a robot system or a vehicle control system, embodiments of the present disclosure can be used for other applications without departing from the spirit and the scope of the present disclosure. Embodiments of the present disclosure provide technical benefits and advance the state of the art in robot or other device control.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein includes systems, methods, and non-transitory computer-readable mediums for curating training data for robot learning based on influence functions. It should also be understood that these embodiments are merely exemplary and are not intended to limit the scope of this disclosure.

What is claimed is:

1. An apparatus, comprising:
one or more processors coupled to one or more memories and configured to:
obtain a plurality of demonstration trajectories;
score each demonstration trajectory of the plurality of demonstration trajectories based on an impact by each demonstration trajectory on a closed-loop performance of a robot policy, the impact by each demonstration trajectory determined based on one or more influence functions;
filter a first subset of demonstration trajectories of the plurality of demonstration trajectories based on a plurality of respective demonstration trajectory scores associated with the first subset of demonstration trajectories;
select a second subset of demonstration trajectories of the plurality of demonstration trajectories based on a plurality of respective demonstration trajectory scores associated with the second subset of demonstration trajectories, the second subset of demonstration trajectories comprising one or more demonstration trajectories that impacted the closed-loop performance of the robot policy more positively or less negatively than the first subset of demonstration trajectories; and
generate a curated dataset that: (i) does not include the first subset of demonstration trajectories, and (ii) includes the second subset of demonstration trajectories.

2. The apparatus of claim 1, wherein the plurality of demonstration trajectories comprise a plurality of robot demonstrations received from a robot, the plurality of robot demonstrations performed using the robot operated or teleoperated by an operator.

3. The apparatus of claim 1, wherein:
the one or more processors are further configured to rank the plurality of demonstration trajectories based on a plurality of respective demonstration trajectory scores associated with the plurality of demonstration trajectories, and
the first subset of demonstration trajectories comprises one or more demonstration trajectories that are ranked lower than each demonstration trajectory of the second subset of demonstration trajectories of the plurality of demonstration trajectories.

4. The apparatus of claim 1, wherein the curated dataset comprises one or more demonstration trajectories that are ranked higher than all other demonstration trajectories of the plurality of demonstration trajectories.

5. The apparatus of claim 4, wherein the one or more processors are configured to select the second subset of demonstration trajectories further based on the one or more demonstration trajectories of the second subset of demonstration trajectories being ranked higher than the first subset of demonstration trajectories.

6. The apparatus of claim 1, wherein the one or more processors are further configured to perform a first-order Taylor approximation on one or more of a leave-one-out impact of a demonstration trajectory or an add-one-in impact of the demonstration trajectory to determine the impact by each demonstration trajectory on the closed-loop performance of the robot policy.

7. The apparatus of claim 1, wherein the one or more influence functions are associated with one or more of a performance inference or an action inference.

8. The apparatus of claim 1, wherein the plurality of demonstration trajectories do not include a successful rollout trajectory.

9. The apparatus of claim 1, wherein:
to obtain the plurality of demonstration trajectories, the one or more processors are configured to obtain one or more newly obtained demonstration trajectories, and
the second subset of demonstration trajectories comprises the one or more newly obtained demonstration trajectories.

10. The apparatus of claim 1, wherein the one or more processors are further configured to train a machine learning model on the curated dataset.

11. A method, comprising:
obtaining a plurality of demonstration trajectories;
scoring each demonstration trajectory of the plurality of demonstration trajectories based on an impact by each demonstration trajectory on a closed-loop performance of a robot policy, the impact by each demonstration trajectory determined based on one or more influence functions;
filtering a first subset of demonstration trajectories of the plurality of demonstration trajectories based on a plurality of respective demonstration trajectory scores associated with the first subset of demonstration trajectories;
selecting a second subset of demonstration trajectories of the plurality of demonstration trajectories based on a plurality of respective demonstration trajectory scores associated with the second subset of demonstration trajectories, the second subset of demonstration trajectories comprising one or more demonstration trajectories that impacted the closed-loop performance of the robot policy more positively or less negatively than the first subset of demonstration trajectories; and
generating a curated dataset that: (i) does not include the first subset of demonstration trajectories, and (ii) includes the second subset of demonstration trajectories.

12. The method of claim 11, wherein the plurality of demonstration trajectories comprise a plurality of robot demonstrations received from a robot, the plurality of robot demonstrations performed using the robot operated or teleoperated by an operator.

13. The method of claim 11, further comprising ranking the plurality of demonstration trajectories based on a plurality of respective demonstration trajectory scores associated with the plurality of demonstration trajectories,
wherein the first subset of demonstration trajectories comprises one or more demonstration trajectories that are ranked lower than each demonstration trajectory of the second subset of demonstration trajectories of the plurality of demonstration trajectories.

14. The method of claim 11, wherein the curated dataset comprises one or more demonstration trajectories that are ranked higher than all other demonstration trajectories of the plurality of demonstration trajectories.

15. The method of claim 14, wherein selecting the second subset of demonstration trajectories is further based on the one or more demonstration trajectories of the second subset of demonstration trajectories being ranked higher than the first subset of demonstration trajectories.

16. The method of claim 11, further comprising performing a first-order Taylor approximation on one or more of a leave-one-out impact of a demonstration trajectory or an add-one-in impact of the demonstration trajectory to determine the impact by each demonstration trajectory on the closed-loop performance of the robot policy.

17. The method of claim 11, wherein the one or more influence functions are associated with one or more of a performance inference or an action inference.

18. The method of claim 11, wherein the plurality of demonstration trajectories do not include a successful rollout trajectory.

19. The method of claim 11, wherein:
obtaining the plurality of demonstration trajectories comprises obtaining one or more newly obtained demonstration trajectories, and
the second subset of demonstration trajectories comprises the one or more newly obtained demonstration trajectories.

20. The method of claim 11, further comprising training a machine learning model on the curated dataset.
